(19) United States
(12) Patent Application Publication
(10) Pub. No.: US 2022/0327489 A1
(43) Pub. Date: Oct. 13, 2022

(54) HIERARCHICAL WORD EMBEDDING SYSTEM

(71) Applicant: NEC Laboratories America, Inc., Princeton, NJ (US)

(72) Inventors: Renqiang Min, Princeton, NJ (US); Iain Melvin, Princeton, NJ (US); Christopher A White, Neshanic Station, NJ (US); Christopher Malon, Fort Lee, NJ (US); Hans Peter Graf, South Amboy, NJ (US)

(21) Appl. No.: 17/714,434

(22) Filed: Apr. 6, 2022

Related U.S. Application Data
(60) Provisional application No. 63/172,166, filed on Apr. 8, 2021.

(51) Int. Cl. G06Q 10/10; G06F 40/279

(52) U.S. Cl. CPC G06Q 10/1053; G06F 40/279; G06F 40/30

(57) ABSTRACT

Systems and methods for matching job descriptions with job applicants is provided. The method includes allocating each of one or more job applicants' curriculum vitae (CV) into sections; applying max pooled word embedding to each section of the job applicants' CVs; using concatenated max-pooling and average-pooling to compose the section embeddings into an applicant's CV representation; allocating each of one or more job position descriptions into specified sections; applying max pooled word embedding to each section of the job position descriptions; using concatenated max-pooling and average-pooling to compose the section embeddings into a job representation; calculating a cosine similarity between each of the job representations and each of the CV representations to perform job-to-applicant matching; and presenting an ordered list of the one or more job applicants or an ordered list of the one or more job position descriptions to a user.

### RELATED APPLICATION INFORMATION

This application claims priority to Provisional Application No. 63/172,166, filed on Apr. 8, 2021, incorporated herein by reference in its entirety.

### BACKGROUND

### Technical Field

The present invention relates to information retrieval and more particularly job-applicant matching.

### Description of the Related Art

A collection of documents is called a corpus. The collection of words or sequences is called a lexicon. These sparse (mostly empty) vectors (lists of numbers) can be represented as dictionaries with key:value pairs. Word embeddings, learned from massive unstructured text data, are widely-adopted building blocks for natural language processing (NLP), such as document classification, sentence classification, and natural language sequence matching. To bridge the gap between word embeddings and text representations, many architectures are proposed to model the compositionality in variable-length pieces of texts. One fundamental research area in NLP is to develop expressive, yet computationally efficient compositional functions that can capture the linguistic structures of natural language sequences.

By representing each word as a fixed-length vector, they can group semantically similar words and explicitly encode abundant linguistic regularities and patterns as well. In the same spirit of learning distributed representations for natural language, many NLP applications also benefit from encoding word sequences (e.g., a sentence or document) into a fixed-length feature vector.

### SUMMARY

According to an aspect of the present invention, a method is provided for matching job descriptions with job applicants. The method includes allocating each of one or more job applicants' curriculum vitae (CV) into specified sections; applying max pooled word embedding to each section of the one or more job applicants' CVs; using concatenated max-pooling and average-pooling to compose the section embeddings into an applicant's CV representation for each of the one or more CVs; allocating each of one or more job position descriptions into specified sections; applying max pooled word embedding to each section of the one or more job position descriptions; using concatenated max-pooling and average-pooling to compose the section embeddings into a job representation for each of the one or more job position descriptions; calculating a cosine similarity between each of the one or more job representations and each of the one or more CV representations to perform job-to-applicant matching; and presenting an ordered list of the one or more job applicants or an ordered list of the one or more job position descriptions to a user.

According to another aspect of the present invention, a computer system is provided for job description matching. The computer system includes one or more processors; computer memory; and a display screen in electronic communication with the computer memory and the one or more processors; wherein the computer memory includes an allocation unit configured to allocate each of one or more job applicants' curriculum vitae (CV) into specified sections, and allocate each of one or more job position descriptions into specified sections; an embedding network configured to apply max pooled word embedding to each section of the one or more job applicants' CVs, and apply max pooled word embedding to each section of the one or more job position descriptions; a concatenation unit configured to use concatenated max-pooling and average-pooling to compose the section embeddings into an applicant's CV representation for each of the one or more CVs, and use concatenated max-pooling and average-pooling to compose the section embeddings into a job representation for each of the one or more job position descriptions; a cosine calculator configured to calculate a cosine similarity between each of the one or more job representations and each of the one or more CV representations to perform job-to-applicant matching; and a display module configured to present an ordered list of the one or more job applicants or an ordered list of the one or more job position descriptions to a user.

According to an aspect of the present invention, a computer readable program is provided for matching job descriptions with job applicants. The computer readable program includes instructions to perform the steps of: allocating each of one or more job applicants' curriculum vitae (CV) into specified sections; applying max pooled word embedding to each section of the one or more job applicants' CVs; using concatenated max-pooling and average-pooling to compose the section embeddings into an applicant's CV representation for each of the one or more CVs; allocating each of one or more job position descriptions into specified sections; applying max pooled word embedding to each section of the one or more job position descriptions; using concatenated max-pooling and average-pooling to compose the section embeddings into a job representation for each of the one or more job position descriptions; calculating a cosine similarity between each of the one or more job representations and each of the one or more CV representations to perform job-to-applicant matching; and presenting an ordered list of the one or more job applicants or an ordered list of the one or more job position descriptions to a user.

These and other features and advantages will become apparent from the following detailed description of illustrative embodiments thereof, which is to be read in connection with the accompanying drawings. A parser breaks up text to create structured numerical data. This can convert your text to tokens that can be, for example, characters, word pieces, single words, numbers, punctuation marks, or a series of words having a discrete sequence (e.g., phrases, clauses, sentences). N-grams can be pairs, triplets, quadruplets, quintuplets, etc., of tokens.

### BRIEF DESCRIPTION OF DRAWINGS

The disclosure will provide details in the following description of preferred embodiments with reference to the following figures wherein:

FIG. 1 is a block/flow diagram illustrating a high-level system/method for calculating similarities between job descriptions and applicants' resumes/CVs, in accordance with an embodiment of the present invention;

FIG. 2 is a block/flow diagram illustrating a system/method for retrieving a list of jobs for a given applicant's CV, in accordance with an embodiment of the present invention;

FIG. 3 is a flow diagram illustrating a system/method for retrieving a list of CVs for a given job description, in accordance with an embodiment of the present invention; and

FIG. 4 is a block diagram illustrating a computer system for CV to Job Description matching, in accordance with an embodiment of the present invention.

### DETAILED DESCRIPTION OF PREFERRED EMBODIMENTS

In accordance with embodiments of the present invention, systems and methods are provided for a variety of models to account for different properties of text sequences, which can be divided into two main categories: simple compositional functions, which largely leverage information from the word embeddings to extract semantic features, and complex compositional functions, which construct words into text representations in a recurrent or convolutional manner and can theoretically capture the word-order features either globally or locally. Convolution is a linear operation that involves the multiplication of a set of weights with the input. The multiplication is performed between an array of input data and a two-dimensional array of weights, called a filter or a kernel.

In one or more embodiments, a simple, fast, and efficient system for job-applicant matching with hierarchical word embedding is provided. The system can efficiently match textual job descriptions with CVs of job applicants, where the key words of the job description and the text of the CV of job applicant do not match.

To emphasize the expressiveness of word embeddings, simple word embeddings-based models (SWEM), which have no compositional parameters, are employed with multilayer perceptron (MLP). Moreover, a max-pooling operation is used over the word embedding matrix, which is demonstrated to extract complementary features with the averaging operation. Pooling can be used to aggregate hidden states at different time steps. Max pooling calculates the maximum value for patches of a feature map. Mean or average pooling calculates the average value for patches of a feature map. Repeated application of the same filter to an input results in a map of activations called a feature map. Sentence or document embedding can be produced by the summation or average over the word embedding of each sequence element, which may be obtained, for example, by word2vec or GloVe. Word embeddings can be used to represent sentences. This type of simple word embedding-based models (SWEM) may not explicitly account for the word order information within a text sequence, but it possesses the desirable properties of tremendously fewer parameter and faster training.

In various embodiments, 300-dimensional GloVe word embeddings can be used for the models.

In various embodiments, Out-of-vocabulary (OOV) words can be initialized from a uniform distribution with the range [−0.01, 0.01].

Given a textual job description and many applicants' resumes/CVs, the system can return a ranked list of applicants' CVs that match the job description.

A job description often has several sections like organization/department name, job title, location, job description, job requirements, etc., and an applicant's resume/CV often have several sections like education, research interests, work experience, working titles, publications, skills, etc.

In various embodiments, hierarchical word embedding without any compositional parameter to compose these sections to get high-level semantic representations of job descriptions and applicants' CVs. Specifically, a job description can be allocated into specified sections as mentioned above, and also allocate a CV into specified sections as mentioned above. We use max-pooled word embedding to represent each section, and then use concatenated max-pooling and average-pooling to compose the section embeddings into a job representation or an applicant's CV representation. We take the embedding vector of each word in a section and perform max pooling over these word embeddings along each embedding dimension to get the vector representation for this section.

A job description can be allocated into specified sections, for example, organization/department name, job title, location, job description, job requirements, etc.

A max-pooled word embedding vector with pooling performed along each embedding dimension can be used to represent each section, and then concatenated max-pooling and average-pooling can be used to compose the section embeddings into a job representation.

There are two approaches to obtaining word embeddings: The first approach fixes the pre-trained GloVe word embeddings and directly uses the max/average-pooled word embedding to represent a job description and applicants' CVs, and the second approach initializes word embeddings with GloVe and then updates the word embeddings by minimizing job-applicant matching loss over a labeled training set (e.g., a standard cross entropy loss over matched/unmatched job-applicant pairs). Finally, we use the cosine similarity of the representations between job description and CV to perform job-applicant matching.

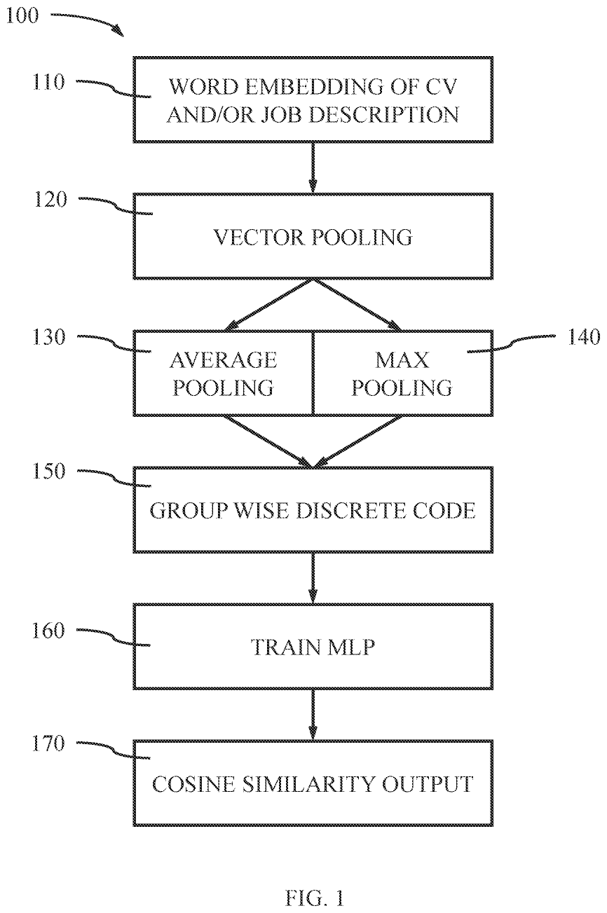

In the first strategy, there is no training and the system is ready to use; In the second strategy, we compile a large dataset of positive and negative job-applicant pairs, and use a multi layer perceptron (MLP) on top of job/CV representations for calculating cosine similarities and a logistic output unit with cross-entropy loss to update the parameters of the MLP and the word embeddings. Specifically, as shown in block 160 of FIG. 1, the MLP is trained with the job/CV representations as input.

To further speed up cosine similarity calculations, we combine all job description representations and CV representations into a larger dataset, and perform product quantification to discretize the representations of job descriptions and CVs. In detail, we split the final embedding representations of jobs/CVs into m segments. If the dimensionality of the final embedding vectors of jobs/CVs is n, the dimensionality of each group is n/m. For each of the m segments, we perform k-means clustering and use the cluster index to discretize the representations of jobs/CVs. The cosine-similarity calculations involving pairwise clusters for each of the m segments can be pre-computed, and the cosine similarities between discretized job/CV representations can be efficiently calculated by looking up the pre-computed tables.

Here m is different from the number of sections, and we can consider that m is the number of pieces (segments) that we cut the final job/CV representation vector into. After we get the cluster centers for each group, we can directly calculate the distances/similarities between pairwise cluster centers, which only needs to be done once (pre-computed). We can perform either the same product quantification (k-means clustering) for both job/CV representations (two sets of vectors combined), or two different product quantifications (run k-means separately) on job and CV representations. After a job and a CV is discretized into a m-dimensional vector, calculating the distances/similarities between these two m-dimensional discrete vectors involving using the pre-computed distances/similarities between different clusters for each of the m segments. For example, we cut the final 12000-dimensional job/CV representation vector into m=3 segments, the discretized job vector is [0, 5, 4], the discretized CV vector is [1, 5, 3], the distance/similarity between [0, 5, 4] and [1, 5, 3] is the sum of the distances/similarity between cluster 1 and cluster 0 for segment 1, the distance similarity between cluster 5 and cluster 5 for segment 2, and the distance/similarity between cluster 4 and cluster 3 for segment 3 (please note that the distances/similarities between clusters are all pre-computed). If we cut them equally, each segment should be 400 dimensional. We run k-means for the 400-d vectors for each segment separately. If we use 10 clusters for each segment, a 400 dimensional continuous vector for each segment can be represented by a cluster center index. In this way, a job/CV can be represented by a 3-dimensional discrete vector (m=3), for e.g., [9, 1, 7].

In various embodiments, a job description and/or an applicant's CV can be divided and allocated into specified sections.

We use max-pooled word embedding to represent each section.

We use concatenated max-pooling and average-pooling to compose the section embeddings into a job representation or an applicant's CV representation.

We use the cosine similarity of the representations between job description and CV to perform job-applicant matching.

We optionally train a MLP on top of job/CV representations for calculating cosine similarities and a logistic output unit with cross-entropy loss to update the parameters of the MLP and the word embeddings based on a large compiled dataset. MLP can learn nonlinear interactions between word embeddings; it can be optional because sometimes word embeddings are expressive enough to some applications. When the MLP is used on top of discrete code, the discrete codes (cluster indices) can be replaced with their associated continuous cluster center vectors. The MLP training is done as usual.

We use product quantification to get groupwise discrete job/CV embeddings: we use k-means clustering and pre-computed cosine-similarity calculations involving pairwise clusters for each group to speed up job-CV cosine similarity calculations.

In various embodiments, we can divide the final representation vector of jobs/applicants into different segments. For each group, we perform k-means clustering. We can use the discrete cluster indices to represent each group, and the distances between pairwise job-group cluster and applicant-group cluster have already been pre-computed for fast job-applicant matching.

Referring now in detail to the figures in which like numerals represent the same or similar elements and initially to FIG. 1, a high-level system/method for calculating similarities between job descriptions and applicants' resumes/CVs is illustratively depicted in accordance with one embodiment of the present invention.

The CV to Job Description matching system 100 can prepare a ranked list of job applicants and job openings based on matching of job descriptions and applicants' resumes/CVs. An ordered list of the one or more job applicants and/or an ordered list of the one or more job position descriptions can be based on a ranking of an outputted classification score.

At block 110, an embedding can be generated for a job applicant's resume/CV, and/or an embedding can be generated for a job description for a posted job opening. The embedding(s) can provide a one-dimensional vector for each resume/CV and/or job posting. A job description and an applicant's CV can be divided and allocated into specified sections. For example, all of a job applicant's education can be treated as a single section and pooled to generate a single vector.

At block 120, the vector generated by the embedding can be pooled to summarize the essential information in the embedding vector. Max-pooled word embedding can then be used to represent each section as a single pooled vector.

At block 130, the vector pooling can be done using average pooling of the embedding vectors.

At block 140, the vector pooling can be done using average pooling of the embedding vectors. Concatenated max-pooling and average-pooling can be used to compose the section embeddings into a job representation or an applicant's CV representation.

At block 150, the pooled vector can be groupwise discrete code based on product quantification.

At block 160, the pooled vectors can be used to train an MLP, where the training can be supervised to minimize a standard cross-entropy loss over a labeled training set with positive and negative job-CV pairs.

At block 170, a cosine similarity can be output from the trained MLP for a single inputted resume/CV or job posting.

If the dimensionality of the final embedding vectors of jobs/CVs is n, the dimensionality of each group is n/m. For each of the m segments, we perform k-means clustering and use the cluster index to discretize the representations of jobs/CVs. The cosine-similarity calculations involving pairwise clusters for each of the m segments can be pre-computed, and the cosine similarities between discretized job/CV representations can be efficiently calculated by looking up the pre-computed tables.

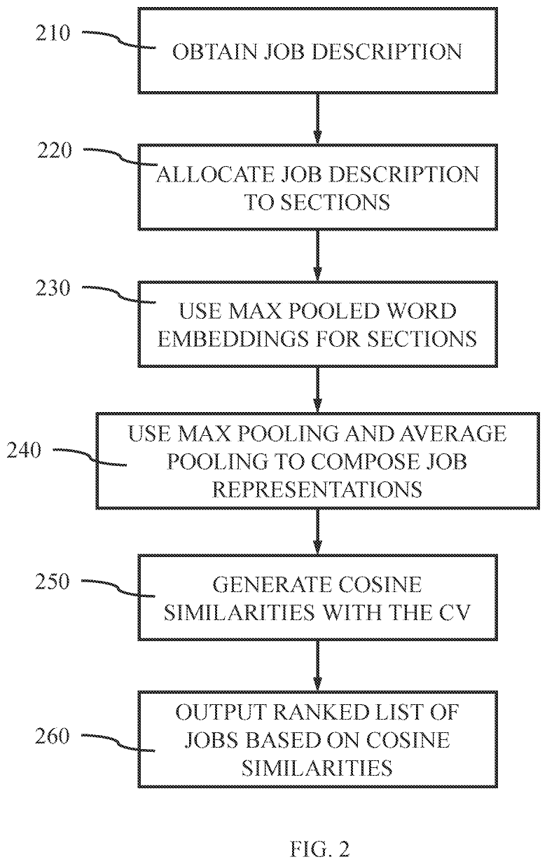

FIG. 2 is a block/flow diagram illustrating a system/method for retrieving a list of jobs for a given applicant's CV, in accordance with an embodiment of the present invention.

At block 210, a new job posting including a job description can be received.

In various embodiments, at block 220, a job description and/or an applicant's CV can be divided and allocated into specified sections.

At block 230, a max-pooled word embedding can be used to represent each section of the job posting/description.

At block 240, a concatenated max-pooling and average-pooling can be used to compose the section embeddings into a job representation or an applicant's CV representation.

At block 250, a cosine similarity of the representations between a list of job descriptions and a given CV can be used to perform job-applicant matching. The lower the value of the cosine similarity, the closer the applicant and the job are related.

At block 260, a ranked list of jobs is outputted by the MLP based on the cosine similarity values between the pooled vectors of the inputted CV and the pooled vectors of the job descriptions. The ranked list of one or more job position descriptions can be based on a ranking of an outputted classification score from the cosine similarity values.

We optionally train a MLP on top of job/CV representations for calculating cosine similarities and a logistic output unit with cross-entropy loss to update the parameters of the MLP and the word embeddings based on large compiled dataset. MLP can learn nonlinear interactions between word embeddings; it can be optional because sometimes word embeddings are expressive enough to some applications.

We use product quantification to get groupwise discrete job/CV embeddings: we use k-means clustering and pre-computed cosine-similarity calculations involving pairwise clusters for each group to speed up job-CV cosine similarity calculations.

In various embodiments, we can divide the final representation vector of jobs/applicants into different segments. For each group, we perform k-means clustering. We can use the discrete cluster indices to represent each group, and the distances between pairwise job-group cluster and applicant-group cluster have already been pre-computed for fast job-applicant matching.

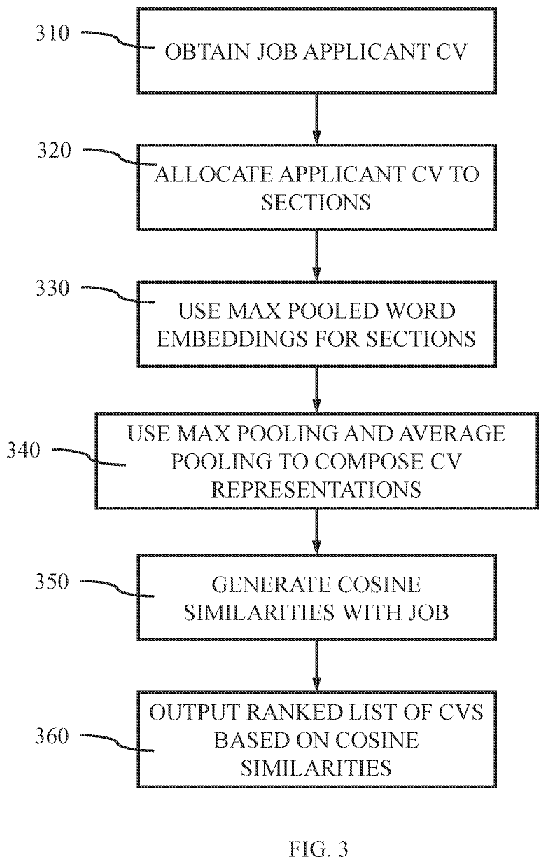

FIG. 3 is a flow diagram illustrating a system/method for retrieving a list of CVs for a given job description, in accordance with an embodiment of the present invention.

At block 310, a new client resume/CV including sections for education, experience, etc., is received.

In various embodiments, at block 320, the applicant's CV can be divided and allocated into specified sections.

At block 330, a max-pooled word embedding can be used to represent each section of the resume/CV.

At block 340, a concatenated max-pooling and average-pooling can be used to compose the section embeddings into an applicant's CV representation.

At block 350, a cosine similarity of the representations between a job description and a list of CVs can be used to perform job-applicant matching. The lower the value of the cosine similarity, the closer the applicant and the job are related.

At block 360, a ranked list of CVs is outputted by the MLP based on the cosine similarity values between the pooled vectors of the inputted CVs and the pooled vector of a job description.

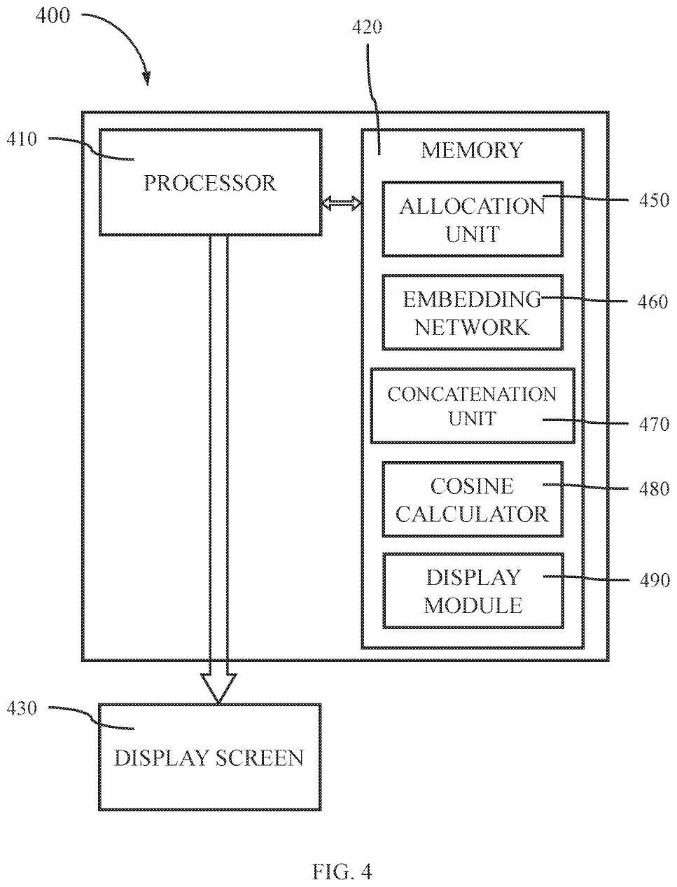

FIG. 4 is a block diagram illustrating a computer system for CV to Job Description matching, in accordance with an embodiment of the present invention.

In one or more embodiments, the computer matching system 400 can include one or more processors 410, which can be central processing units (CPUs), graphics processing units (GPUs), and combinations thereof, and a computer memory 420 in electronic communication with the one or more processors 410, where the computer memory 420 can be random access memory (RAM), solid state drives (SSDs), hard disk drives (HDDs), optical disk drives (ODD), etc. The memory 420 can be configured to store the CV to Job Description matching system 100, including an allocation unit 450, embedding network 460, concatenation unit 470, cosine calculator 480, and display module 490. The allocation unit 450 can be configured to allocate each of one or more job applicants' curriculum vitae (CV) into specified sections, and allocate each of one or more job position descriptions into specified sections. The embedding network 460 can be a neural network configured to apply max pooled word embedding to each section of the one or more job applicants' CVs, and apply max pooled word embedding to each section of the one or more job position descriptions. The concatenation unit 470 can be configured to use concatenated max-pooling and average-pooling to compose the section embeddings into an applicant's CV representation for each of the one or more CVs, and use concatenated max-pooling and average-pooling to compose the section embeddings into a job representation for each of the one or more job position descriptions. The cosine calculator 480 can be configured to calculate a cosine similarity between each of the one or more job representations and each of the one or more CV representations to perform job-to-applicant matching. The display module 490 can be configured to present an ordered list of the one or more job applicants or an ordered list of the one or more job position descriptions to a user. The memory 420 and one or more processors 410 can be in electronic communication with a display screen 430 over a system bus and I/O controllers, where the display screen 430 can present the ranked list of job descriptions and/or job applicants.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for matching job descriptions with job applicants, comprising:
allocating each of one or more job applicants' curriculum vitae (CV) into specified sections;
applying max pooled word embedding to each section of the one or more job applicants' CVs;
using concatenated max-pooling and average-pooling to compose the section embeddings into an applicant's CV representation for each of the one or more CVs;
allocating each of one or more job position descriptions into specified sections;
applying max pooled word embedding to each section of the one or more job position descriptions;
using concatenated max-pooling and average-pooling to compose the section embeddings into a job representation for each of the one or more job position descriptions;
calculating a cosine similarity between each of the one or more job representations and each of the one or more CV representations to perform job-to-applicant matching; and
presenting an ordered list of the one or more job applicants or an ordered list of the one or more job position descriptions to a user.

2. The method of claim 1, wherein a multilayer perceptron (MLP) is utilized for applying max pooled word embedding to each section of the one or more job applicants' CVs.

3. The method of claim 2, wherein a multilayer perceptron (MLP) is utilized for applying average pooled word embedding to each section of the one or more job position descriptions.

4. The method of claim 3, wherein k-means clustering is used to speed up the job-CV cosine similarity calculations.

5. The method of claim 4, wherein pre-computed cosine-similarity calculations involving pairwise clusters is used for each group to speed up the job-CV cosine similarity calculations.

6. The method of claim 5, wherein a logistic output unit with cross-entropy loss is used to update the parameters of the MLP, and the word embeddings are based on a compiled dataset.

7. The method of claim 6, wherein the ordered list of the one or more job applicants and/or the ordered list of the one or more job position descriptions is based on a ranking of an outputted classification score.

8. A computer system for job description matching, comprising:
one or more processors;
computer memory; and
a display screen in electronic communication with the computer memory and the one or more processors;
wherein the computer memory includes an allocation unit configured to allocate each of one or more job applicants' curriculum vitae (CV) into specified sections, and allocate each of one or more job position descriptions into specified sections;
an embedding network configured to apply max pooled word embedding to each section of the one or more job applicants' CVs, and apply max pooled word embedding to each section of the one or more job position descriptions;
a concatenation unit configured to use concatenated max-pooling and average-pooling to compose the section embeddings into an applicant's CV representation for each of the one or more CVs, and use concatenated max-pooling and average-pooling to compose the section embeddings into a job representation for each of the one or more job position descriptions;
a cosine calculator configured to calculate a cosine similarity between each of the one or more job representations and each of the one or more CV representations to perform job-to-applicant matching; and
a display module configured to present an ordered list of the one or more job applicants or an ordered list of the one or more job position descriptions to a user.

9. The system of claim 8, wherein a multilayer perceptron (MLP) is utilized for applying max pooled word embedding to each section of the one or more job applicants' CVs.

10. The system of claim 9, wherein a multilayer perceptron (MLP) is utilized for applying average pooled word embedding to each section of the one or more job position descriptions.

11. The system of claim 10, wherein k-means clustering is used to speed up the job-CV cosine similarity calculations.

12. The system of claim 11, wherein pre-computed cosine-similarity calculations involving pairwise clusters is used for each group to speed up the job-CV cosine similarity calculations.

13. The system of claim 12, wherein a logistic output unit with cross-entropy loss is used to update the parameters of the MLP, and the word embeddings are based on a compiled dataset.

14. The system of claim 13, wherein the ordered list of the one or more job applicants and/or the ordered list of the one or more job position descriptions is based on a ranking of an outputted classification score.

15. A non-transitory computer readable storage medium comprising a computer readable program for job description matching, wherein the computer readable program when executed on a computer causes the computer to perform the steps of:
allocating each of one or more job applicants' curriculum vitae (CV) into specified sections;
applying max pooled word embedding to each section of the one or more job applicants' CVs;
using concatenated max-pooling and average-pooling to compose the section embeddings into an applicant's CV representation for each of the one or more CVs;
allocating each of one or more job position descriptions into specified sections;
applying max pooled word embedding to each section of the one or more job position descriptions;
using concatenated max-pooling and average-pooling to compose the section embeddings into a job representation for each of the one or more job position descriptions;
calculating a cosine similarity between each of the one or more job representations and each of the one or more CV representations to perform job-to-applicant matching; and
presenting an ordered list of the one or more job applicants or an ordered list of the one or more job position descriptions to a user.

16. The computer readable program of claim 15, wherein a multilayer perceptron (MLP) is utilized for applying max pooled word embedding to each section of the one or more job applicants' CVs.

17. The computer readable program of claim 16, wherein a multilayer perceptron (MLP) is utilized for applying average pooled word embedding to each section of the one or more job position descriptions.

18. The computer readable program of claim 17, wherein k-means clustering is used to speed up the job-CV cosine similarity calculations.

19. The computer readable program of claim 18, wherein pre-computed cosine-similarity calculations involving pairwise clusters is used for each group to speed up the job-CV cosine similarity calculations.

20. The computer readable program of claim 19, wherein a logistic output unit with cross-entropy loss is used to update the parameters of the MLP, and the word embeddings are based on a compiled dataset, wherein the ordered list of the one or more job applicants and/or the ordered list of the one or more job position descriptions is based on a ranking of an outputted classification score.
